(19) United States
(12) Patent Application Publication
(10) Pub. No.: US 2013/0067119 A1
(43) Pub. Date: Mar. 14, 2013

(54) BOOT UP CONFIGURATION WITH USB DATA PINS IN EMBEDDED SYSTEMS

(71) Applicant: Chi Kwok Wong, Shatin (HK)

(72) Inventor: Chi Kwok Wong, Shatin (HK)

(21) Appl. No.: 13/228,443

(22) Filed: Sep. 9, 2011

(51) Int. Cl. G06F 3/00

(52) U.S. Cl. 710/10

(57) ABSTRACT

A method for setting boot up configuration in an embedded system includes pulling the DP data pin of a USB interface to the ground by the embedded system, pulling the DM data pin of the USB interface to the ground by the embedded system, and booting up the embedding system into a special mode when at least one of the DP data pin or the DM data pin is externally pulled up above a threshold value.

### BACKGROUND OF THE INVENTION

The present disclosure relates to technologies related to embedded systems.

An embedded system is a computer system designed to perform dedicated functions. It is embedded as part of a complete device often including hardware and mechanical parts. Embedded systems usually boot up into the target application in normal conditions. However, some situations require embedded systems to be booted up to a special mode. Examples of special boot modes include diagnostic mode for functional check of the hardware, firmware update mode for re-programming the non-volatile memory of the system, etc.

Boot up configuration is traditionally supported by changes in firmware detectable status. This is usually achieved by pulling chosen I/O pins to a particular state, or by special buttons/switches combination. Pulling of I/O pins is rarely adopted at product level, due to extra effort of sparing a connector for the chosen I/O pins.

Boot up configuration by special buttons/switches combination is commonly adopted. However, this approach is only suitable for products that are equipped with sufficient buttons/switches to make the special combination. It is important to note that the special buttons/switches combination should be carefully chosen so that the end user will not easily get into the special boot up mode unintentionally.

A challenge therefore exists for products that have few or no buttons/switches (aside from the power button/switch). For these products, booting up into a special mode cannot be achieved easily.

### SUMMARY OF THE INVENTION

The present application discloses a new approach to make use of the USB port alone to selectively boot up into special modes.

In a general aspect, the present invention relates to a method for setting boot up configuration in an embedded system having a Universal Serial Bus (USB) interface. The method includes pulling the DP data pin of the USB interface to the ground by the embedded system; pulling the DM data pin of the USB interface to the ground by the embedded system; and booting up the embedding system into a special mode when at least one of the DP data pin or the DM data pin is externally pulled up above a threshold value.

Implementations of the system may include one or more of the following. A first resistor in the embedded system can be connected to the ground and the DP data pin of the USB interface. A second resistor in the embedded system can be connected to the ground and the DM data pin of the USB interface. The embedding system can be boot up into a special mode when at least one of the DP data pin or the DM data pin is externally pulled up to VDD. The embedding system can be boot up into a special mode when the DP data pin is externally pulled up above the threshold value. The embedding system can be boot up into a special mode when the DM data pin is externally pulled up above the threshold value. The embedding system can be boot up into a special mode when both the DM data pin and the DM data pin are externally pulled up above the threshold value. The embedded system can operate as a USB host, a USB device, or a device with no USB connectivity. The method can further include booting up the embedding system into a normal mode when the DP data pin and the DM data pin are detected to have zero logic values by the embedded system. The DP data pin and the DM data pin can be pulled to the ground by a host computer. The method can further include pulling the DP data pin of the USB interface to VDD by the embedded system; and allowing the embedded system to operate as a full-speed USB device. The method can further include pulling the DM data pin of the USB interface to VDD by the embedded system; and allowing the embedded system to operate as a low-speed USB device.

In a general aspect, the present invention relates to an embedded system that includes a Universal Serial Bus (USB) interface having a DP data pin and DM data pin; a first resistor configured to be connected to the ground and the DP data pin; and a second resistor configured to be connected to the ground and the DM data pin, wherein the embedded system can boot up into a special mode when at least one of the DP data pin or the DM data pin is externally pulled up above a threshold value.

Implementations of the system may include one or more of the following. The embedding system can boot up into a special mode when at least one of the DP data pin or the DM data pin is externally pulled up to VDD. The embedding system can boot up into a special mode when the DP data pin or the DM data pin is externally pulled up above the threshold value, wherein the embedded system operates as a USB device or a device with no USB connectivity. The embedding system can boot up into a special mode when both the DP data pin and the DM data pin are externally pulled up above the threshold value, wherein the embedded system operates as a USB host, a USB device, or a device with no USB connectivity. The embedding system can boot up the embedding system into a normal mode when the DP data pin and the DM data pin are externally set to zero logic values. The embedding system can pull the DP data pin of the USB interface, and wherein the embedding system can operate as a full-speed USB device. The embedding system can pull the DM data pin of the USB interface to VDD, and wherein the embedding system can operate as a low-speed USB device.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a block diagram of an improved embedded systems in accordance with the present invention.

FIG. 2 is a schematic diagram of a host computer having a USB interface configured to interface with an embedded system.

FIG. 3A is a schematic diagram showing an embedded system connected to a host computer as a full speed USB device for a normal boot up in accordance with the present invention.

FIG. 3B a schematic diagram showing an embedded system connected to a host computer as a low speed USB device for a normal boot up in accordance with the present invention.

FIG. 4A is a schematic diagram of an embedded system having DP and DM data pins pulled to the ground.

FIG. 4B is a schematic diagram of an embedded system triggered into the special boot up mode when the DP data pin is externally pulled to VDD.

FIG. 4C is a schematic diagram of an embedded system triggered into the special boot up mode when the DM data pin is externally pulled to VDD.

FIG. 4D is a schematic diagram of an embedded system triggered into the special boot up mode when both DP and BM data pins are externally pulled to VDD.

### DETAILED DESCRIPTION OF THE INVENTION

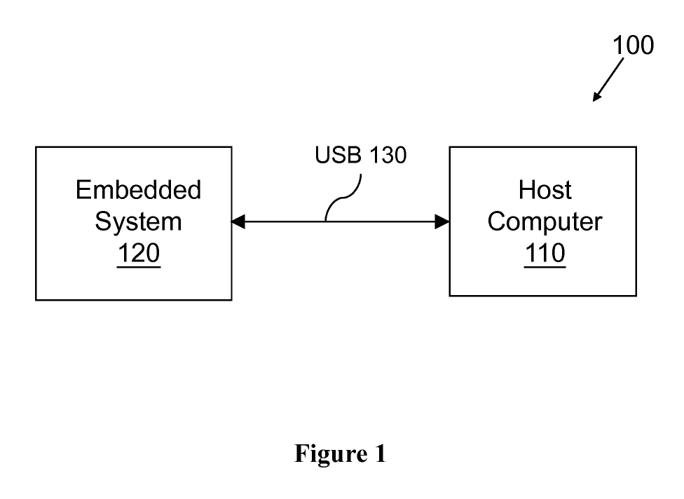

Referring to FIG. 1, a system 100 for software development and debugging, or the product usages of an embedded system includes a host computer 110 and an embedded system 120. In product usage and in software development, the embedded system 120 with Universal Serial Bus (USB) module can be configured as USB devices. The host computer 110 is often implemented by a personal computer, which is called an USB host of the embedded system 120 acting as a USB device.

The embedded system 120 has a built-in USB connection, which is used for transferring application data for developing the embedded applications as well as for debugging purposes. The host computer 110 and the embedded system 120 can be so configured to allow the application and the debugging channels to be multiplexed in a single USB 130. In comparison to the convention systems, the system 100 is simplified by the removal of an interface unit. Another advantage is that the embedded system is no longer required to have I/O pins for the debugging channel (e.g. via an interface unit). The I/O pins can thus be re-allocated for other purposes. This reduction in I/O pins can be of significant importance in embedded systems with low I/O pin count. Details about the system 100 for software development and debugging for an embedded system are disclosed in the commonly assigned pending U.S. patent application Ser. No. 12/861,035, titled “Multiplexing application and debug channels on a single USB connection”, filed Aug. 23, 2010 by the same inventor, the content of which is incorporated herein by reference.

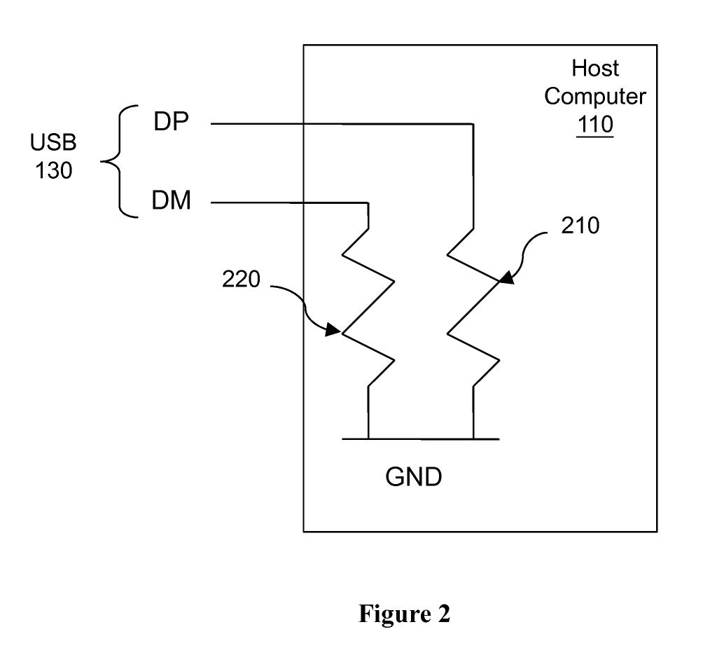

As shown in FIG. 2, the USB 130 includes data pins called DP and DM pins, which are referred as D+/D− pins in the Universal Serial Bus Specification (Revision 2.0). In normal conditions, the host computer 110 weakly pulls the DP and DM pins to the ground by respectively connecting with high resistances resistors 210 and 220 to the ground.

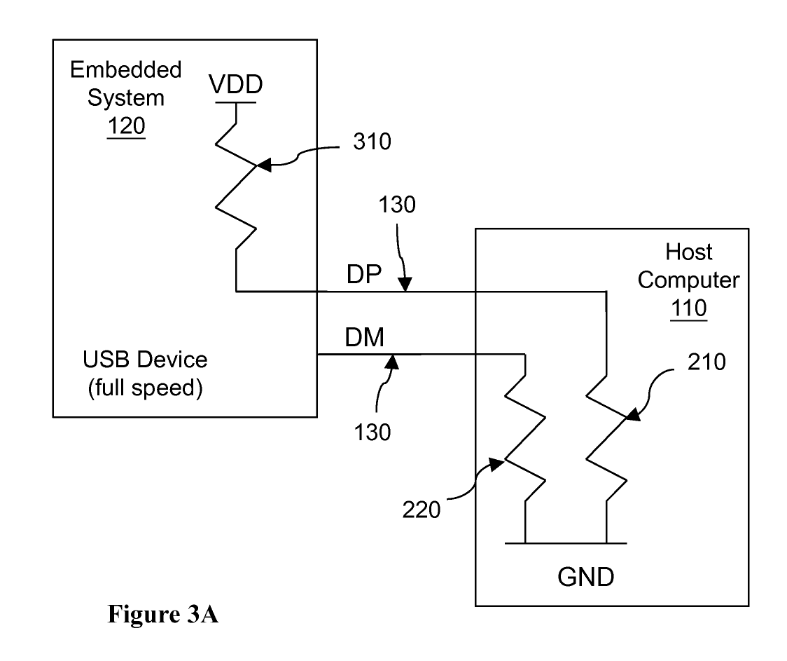

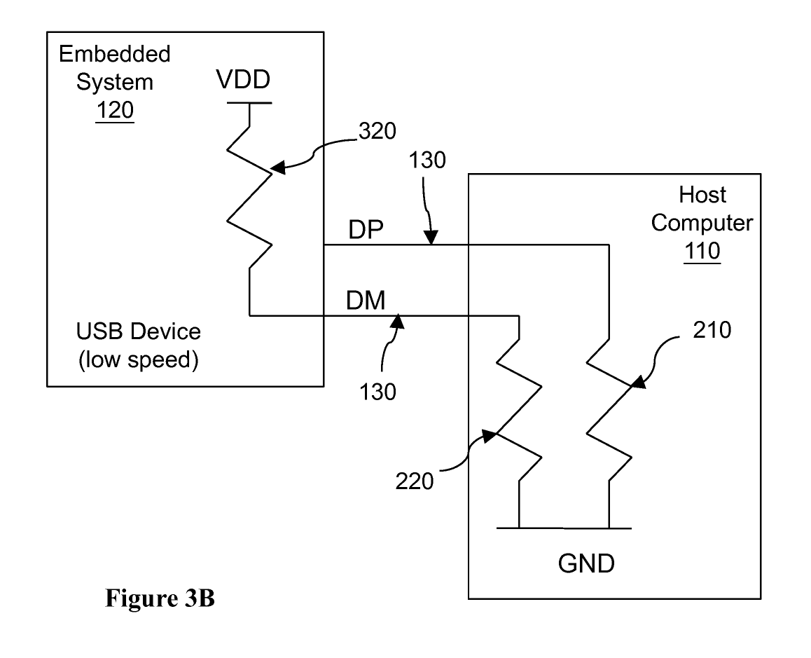

When the embedded system 120 is connected to the host computer 110, as shown in FIG. 3A, the embedded system 120 strongly pulls the DP pin to VDD via a low-resistance resistor 310. In this configuration, the embedded system 120 is boot up normally into target application as a full speed (i.e. full-bandwidth) USB device operating at a bit clock of 12 Mbps.

Alternatively, the embedded system 120 can also strongly pull the DM pin to VDD via a low-resistance resistor 320. The embedded system 120 is also boot up normally into target application as a low speed (i.e. low-bandwidth) USB device operating at a bit clock of 1.5 Mbps.

By detecting the different voltage values in the DP and DM pins, the host computer 110 can determine whether the embedded system 120 connected is a full-speed or low-speed device.

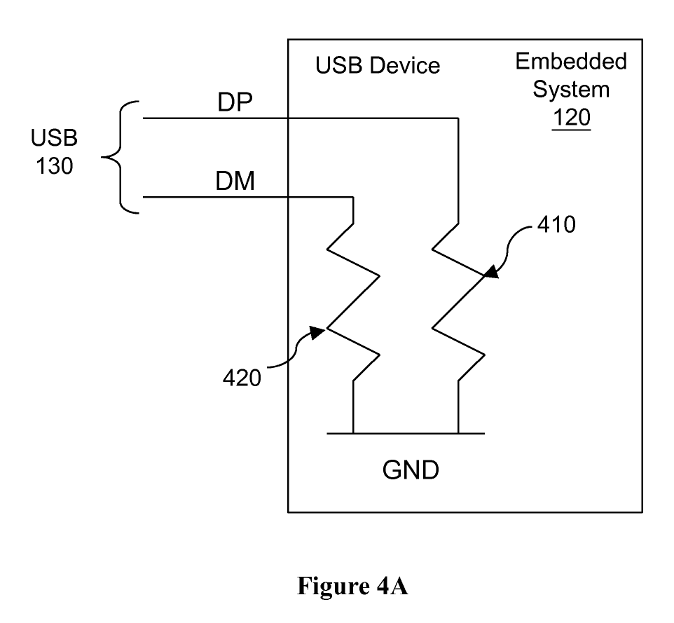

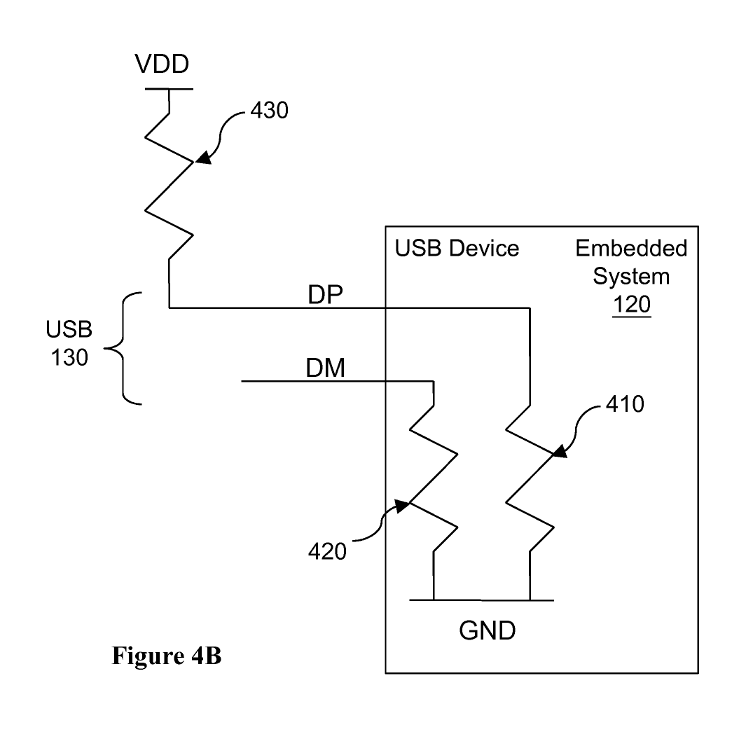

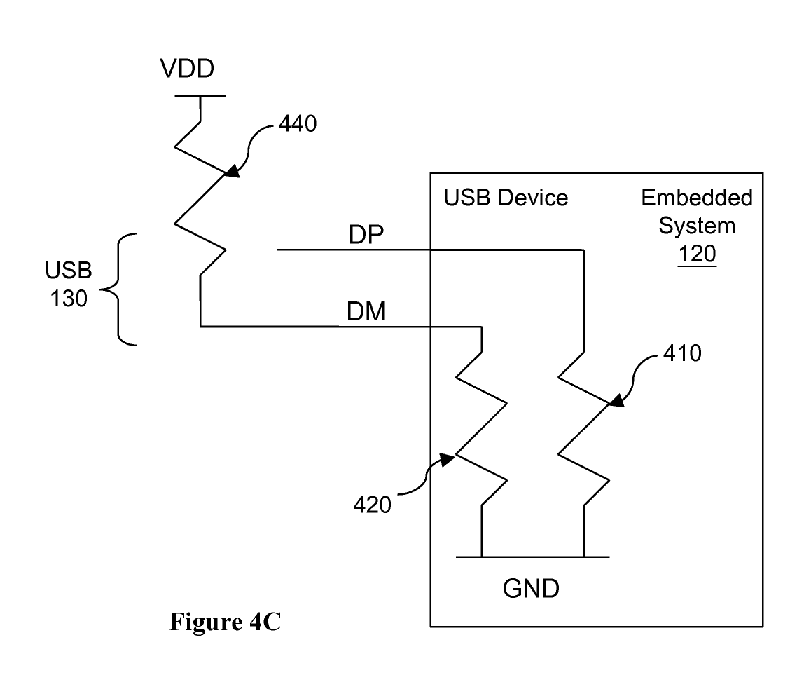

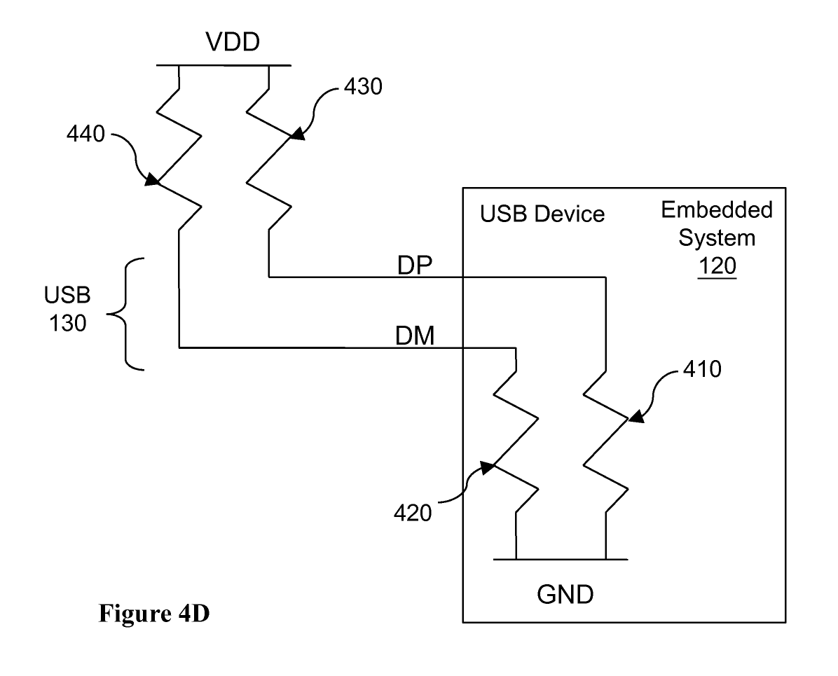

To realize boot up configuration, referring to FIG. 4A, the embedded system 120 weakly pulls both DP and DM pins to ground during boot up by resistors 410, 420 respectively. The status of DP and DM pins can then be sensed. The DP/DM pins both have 0 values if the USB port is unconnected.

If the DP and DM pins are detected as having 0 logic values by the embedded system 120 after it is connected to the host computer 110 via the USB 130, the embedded system 120 recognizes the condition as for a normal boot up. The embedded system 120 can pull the DP pin to VDD to identify itself as a full speed device (FIG. 3A) to the host computer 110, or can pull the DM pin to VDD to identify itself as a low speed device (FIG. 3B) to the host computer 110.

In accordance with the present invention, the embedded system 120 can be triggered into the special boot up mode by one of the following events:
a) If the DP pin is externally pulled above a threshold value. As shown in FIG. 4B, the DP pin is pulled up to VDD by a resistor 430. The voltages of DP and DM pins are detected as 1/0 respectively by the embedded system 120. The resistor 430 has a smaller resistance than that of the resistor 410.
b) If the DM pin is externally pulled above a threshold value. As shown in FIG. 4C, the DM pin is pulled up to VDD by a resistor 440. The voltages of DP and DM pins are detected as 0/1 respectively by the embedded system 120. The resistor 440 has a smaller resistance than that of the resistor 420.
c) Both the DP and DM pins are externally pulled above a threshold value. As shown in FIG. 4D, the DP and DM pins are pulled up to VDD respectively by resistors 430, 440 connected to VDD. DP and DM pins are detected as 1/1 respectively.

When the embedded system being triggered into a special boot mode, the embedded system 120 is not connected to a host computer. The data pins of the USB interface can be externally pulled up by a special adapter that is connected to the USB port of the embedded system 120. The voltage pull-up of the USB data pins can also be achieved by other types of external resister(s) applied as the trigger.

After the embedded system 120 is triggered into a special boot mode, it can operate as a USB host, as a USB device, or a device with no USB connectivity. The embedded system 120 may or may not be connected to a host computer, depending on the functionalities of the embedded system 120. An exception is for triggering events (a) and (b) during which the embedded system 120 cannot function as a USB host in normal boot mode. This is because in normal boot up mode the embedded system operating as a USB host has the identical conditions as triggering events (a) and (b) when it is respectively connected with a full or low speed device. Under such conditions, the embedded system will not be able to distinguish whether it is a normal or special boot up mode.

An advantage of the presently disclosed method is that the triggering the embedded system 120 into the special boot up mode is accomplished by standard data pins in USB interfaces. No extra or dedicated pins are used in the presently disclosed methods.

The disclosed invention may include one or more of the following advantages. First, the disclosed system and methods are applicable to products or devices which are not equipped with buttons/switches that are suitable for boot up configurations. Moreover, the disclosed system and methods can prevent miss-trigger of special boot modes. It is almost impossible that the DP and DM pins are pulled to a special state unintentionally.

It is understood that the disclosed circuit and methods are compatible with other configurations of the electronic components and variations in circuit designs without deviation from the spirit of the present specification. For example, the exact layout and connectivity of the hardware and the software modules for data multiplexing may vary without deviating from the present invention. The disclosed improved system can be applied to a wide range of embedded systems such as micro controllers for a mass storage device, web cameras, USB speaker, docks for smart phones, USB hub, USB card reader, etc. The disclosed systems and methods are compatible with different USB standards such as USB 1.x, USB 2.0, USB 3.0, Type A, Type B, Mini-A, Mini-B, Micro-AB, and Micro-B, etc.

What is claimed is:

1. A method for setting boot up configuration in an embedded system having a Universal Serial Bus (USB) interface, comprising:
pulling the DP data pin of the USB interface to the ground by the embedded system;
pulling the DM data pin of the USB interface to the ground by the embedded system;
detecting, by the embedded system, that at least one of the DP data pin or the DM data pin is externally pulled up above a threshold value; and
booting up the embedding system into a special mode.

2. The method of claim 1, wherein a first resistor in the embedded system is connected to the ground and the DP data pin of the USB interface, wherein a second resistor in the embedded system is connected to the ground and the DM data pin of the USB interface.

3. The method of claim 1, wherein the embedding system is boot up into a special mode when at least one of the DP data pin or the DM data pin is externally pulled up to VDD.

4. The method of claim 1, wherein the embedding system is boot up into a special mode when the DP data pin is externally pulled up above the threshold value.

5. The method of claim 4, wherein the embedded system operates as a USB device or a device with no USB connectivity.

6. The method of claim 1, wherein the embedding system is boot up into a special mode when the DM data pin is externally pulled up above the threshold value.

7. The method of claim 6, wherein the embedded system operates as a USB device or a device with no USB connectivity.

8. The method of claim 1, wherein the embedding system is boot up into a special mode when both the DP data pin and the DM data pin are externally pulled up above the threshold value.

9. The method of claim 8, wherein the embedded system operates as a USB host, a USB device, or a device with no USB connectivity.

10. The method of claim 1, further comprising:
booting up the embedding system into a normal mode when the DP data pin and the DM data pin are detected to have zero logic values by the embedded system.

11. The method of claim 10, wherein the DP data pin and the DM data pin are pulled to the ground by an external device.

12. The method of claim 10, further comprising:
pulling the DP data pin of the USB interface to VDD by the embedded system; and
allowing the embedded system to operate as a full-speed USB device.

13. The method of claim 10, further comprising:
pulling the DM data pin of the USB interface to VDD by the embedded system; and
allowing the embedded system to operate as a low-speed USB device.

14. An embedded system, comprising:
a Universal Serial Bus (USB) interface having a DP data pin and DM data pin;
a first resistor configured to be connected to the ground and the DP data pin; and
a second resistor configured to be connected to the ground and the DM data pin, wherein the embedded system is configured to boot up into a special mode when at least one of the DP data pin or the DM data pin is externally pulled up above a threshold value.

15. The embedded system of claim 14, wherein the embedding system is configured to boot up into a special mode when at least one of the DP data pin or the DM data pin is externally pulled up to VDD.

16. The embedded system of claim 14, wherein the embedding system is configured to boot up into a special mode when the DP data pin or the DM data pin is externally pulled up above the threshold value, wherein the embedded system operates as a USB device or a device with no USB connectivity.

17. The embedded system of claim 14, wherein the embedding system is configured to boot up into a special mode when both the DP data pin and the DM data pin are externally pulled up above the threshold value, wherein the embedded system operates as a USB host, a USB device, or a device with no USB connectivity.

18. The embedded system of claim 14, wherein the embedding system is configured to boot up the embedding system into a normal mode when the DP data pin and the DM data pin are externally set to zero logic values.

19. The embedded system of claim 18, wherein the embedding system is configured to pull the DP data pin of the USB interface to VDD, and wherein the embedding system is configured to operate as a full-speed USB device.

20. The embedded system of claim 18, wherein the embedding system is configured to pull the DM data pin of the USB interface to VDD, and wherein the embedding system is configured to operate as a low-speed USB device.
